(19) United States
(12) Patent Application Publication
(10) Pub. No.: US 2023/0115780 A1
(43) Pub. Date: Apr. 13, 2023

(54) Demonstration Model For Osteotomy Surgical Procedures

(71) Applicant: Apodeixis, LLC, Silver Spring, MD (US)

(72) Inventor: Owen Thompson Fink, Silver Spring, MD (US)

(73) Assignee: Apodeixis, LLC, Silver Spring, MD (US)

(21) Appl. No.: 17/956,405

(22) Filed: Sep. 29, 2022

Related U.S. Application Data
(60) Provisional application No. 63/253,495, filed on Oct. 7, 2021.

(51) Int. Cl. G09B 23/34; G09B 23/32

(52) U.S. Cl. CPC G09B 23/34; G09B 23/32

(57) ABSTRACT

A three-dimensional model for demonstrating an osteotomy surgical procedure is provided. The three-dimensional model includes a support, a healthy hip with a socket, a diseased hip with a socket, a healthy femur, a diseased femur with a removable proximal portion, a removable spacer for the healthy hip socket, a removable socket insert for the diseased hip socket, a ball socket insert to replace the socket insert, and a femoral implant to replace the diseased femur proximal portion.

### CROSS-REFERENCE TO RELATED APPLICATIONS

This application claims the benefit of U.S. provisional patent application Ser. No. 63/253,495 (filed on Oct. 7, 2021), the contents of which is incorporated herein by reference in its entirety.

### BACKGROUND

The present disclosure relates to demonstration models. More particularly, the present disclosure relates to a demonstration model for an osteotomy surgical procedure.

Some approaches to demonstrate and provide instruction for surgical procedures use human and/or animal cadavers, such as canine, porcine, or bovine cadaver specimens. While helpful, these cadaver specimens are often very costly and may create biohazard waste issues. Furthermore, the usefulness of cadaver models may be limited. For example, although cadaver tissues provide an accurate representation of anatomical geometry, the required chemical preservation, such as embalming fluid, which may include formaldehyde, methanol, glutaraldehyde, greatly alters the physical properties of the tissues. Therefore, it would be useful to provide an improved approach to demonstrate surgical procedures that does not rely upon cadavers.

### BRIEF DESCRIPTION OF THE DRAWINGS

FIGS. 1A, 1B, 1C and 1D depict front, left oblique, right oblique and top views, respectively, of a demonstration model, in accordance with embodiments of the present disclosure.

FIGS. 2A and 2B depict front and rear views, respectively, of a healthy femur, in accordance with embodiments of the present disclosure.

FIG. 3A depicts a front view of a diseased femur with a removable proximal portion, in accordance with embodiments of the present disclosure.

FIGS. 3B and 3C depict front and rear views, respectively, of diseased femur without a removable proximal portion, in accordance with embodiments of the present disclosure.

FIGS. 4A and 4B depict top and bottom views, respectively, of a proximal portion of a diseased femur, in accordance with embodiments of the present disclosure.

FIG. 5A depicts a side view of a femoral implant, in accordance with embodiments of the present disclosure.

FIG. 5B depicts a front view of a diseased femur with a femoral implant, in accordance with embodiments of the present disclosure.

FIGS. 6A and 6B depict top and bottom views, respectively, of a removable socket insert, in accordance with embodiments of the present disclosure.

FIGS. 7A and 7B depict top and bottom views, respectively, of a removable ball socket insert, in accordance with embodiments of the present disclosure.

FIG. 8A depicts a front isometric view of a demonstration model showing a hip socket or recess in a healthy hip, in accordance with embodiments of the present disclosure.

FIG. 8B depicts a front isometric view of a demonstration model showing a removable spacer disposed in a recess in a healthy hip, in accordance with embodiments of the present disclosure.

FIGS. 9A and 9B depict top and bottom views, respectively, of a removable spacer, in accordance with embodiments of the present disclosure.

FIG. 10A depicts a rear view of a demonstration model showing a storage cavity for a removable spacer, in accordance with embodiments of the present disclosure.

FIG. 10B depicts rear view of a demonstration model showing a removable spacer disposed in a storage cavity located in a diseased hip, in accordance with embodiments of the present disclosure.

FIG. 11A depicts a front isometric view of a demonstration model showing a hip socket or recess in a diseased hip, in accordance with embodiments of the present disclosure.

FIG. 11B depicts a front isometric view of a demonstration model showing a head of a femoral implant coupled to a ball socket insert in a diseased hip, in accordance with embodiments of the present disclosure.

FIGS. 12A, 12B and 12C depict front, rear and oblique views, respectively, of a demonstration model with a femoral implant, a ball socket insert, and a removable spacer, in accordance with embodiments of the present disclosure.

### DETAILED DESCRIPTION

Embodiments of the present disclosure will now be described with reference to the drawing figures, in which like reference numerals, characters and labels refer to like parts throughout.

Embodiments of the present disclosure advantageously provide three dimensional, transforming demonstration models that illustrate the way different osteotomy surgical procedures change the geometry of the relevant bones from a pre-surgical state to a post-surgical state.

More particularly, embodiments of the present disclosure provide a three dimensional, transforming model used to demonstrate to dog owners the anatomy and function of a dog's hip, the dysfunction caused by a shallow, dysplastic hip, the progression to osteoarthritis, and treatment via Femoral Head and Neck Ostectomy surgery or Total Hip Replacement surgery.

Generally, the demonstration model represents a dog's pelvis, i.e., two hip joints or hips, and two removable femurs. A base with a vertical support is attached to the pelvis. Each femur is coupled to the pelvis at the respective hip. A removable spacer may be placed into one hip socket (or cavity), and affixed or coupled thereto with an embedded magnet, etc. The demonstration model advantageously transforms one hip from a normal, healthy hip state to a shallow, dysplastic hip state, and the other hip from a diseased, dysplastic, arthritic hip state to a partial or total hip replacement state that has been surgically treated via femoral head and neck ostectomy. For each hip, the femur may be removed to show the separate shapes of the femur and pelvis, and their interaction within the hip socket.

The normal (healthy) hip and the normal (healthy) femur have normal, deep, ball-and-socket anatomy. The healthy femur may be used to show the normal anatomy, the normal, smooth motion of a healthy hip, and the supportive strength provided by a normal, deep hip socket. When placed in the socket of the healthy hip, the removable spacer renders the socket shallower, allowing the user to see the decreased stability and strength caused by a shallow, dysplastic hip. In one embodiment, the removable spacer includes at least one embedded magnet; in other embodiments, at least a portion of the removable spacer is a ferromagnetic material, etc. When not in use, this spacer may be stored in a storage cavity located in the healthy hip, the diseased hip, the base cover, etc.

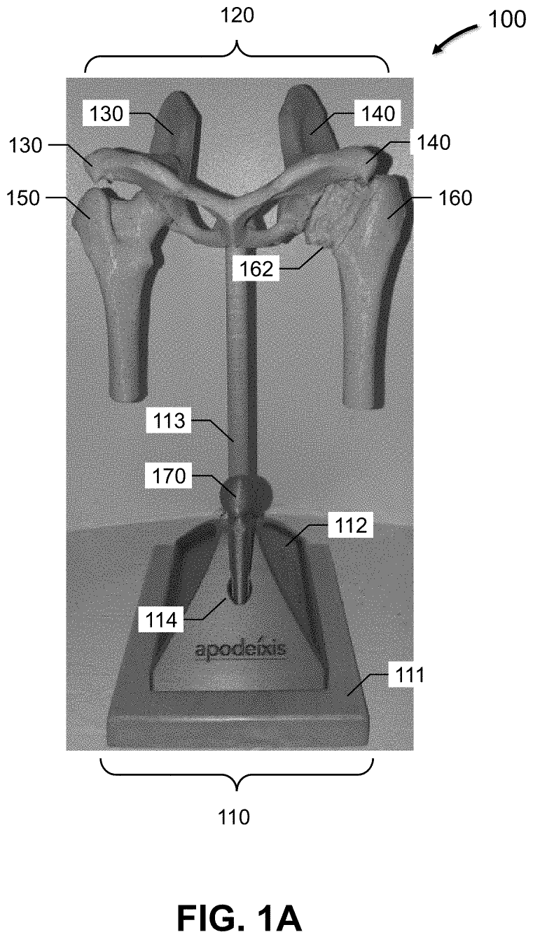

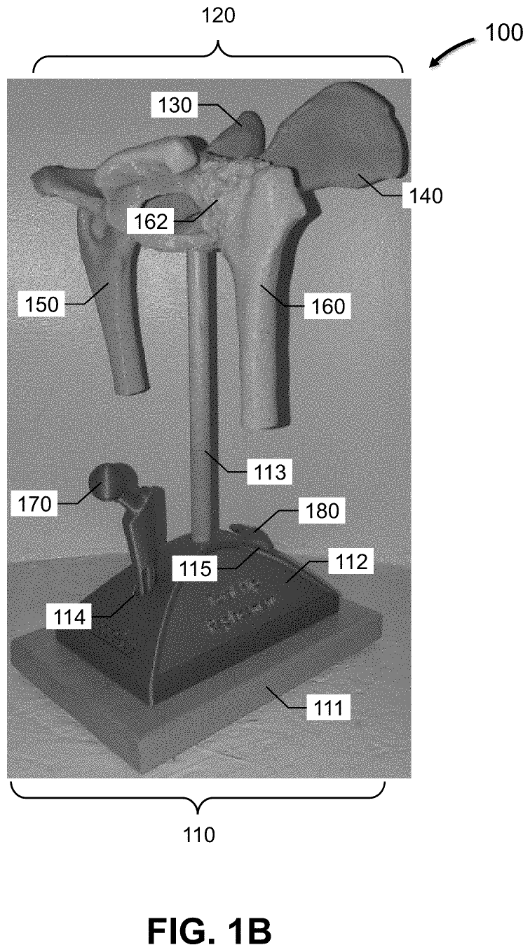

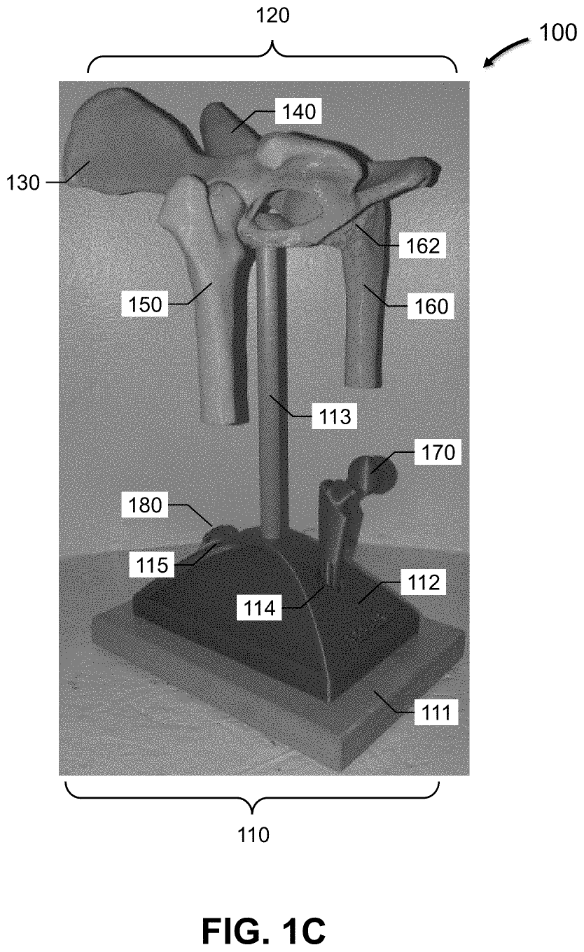

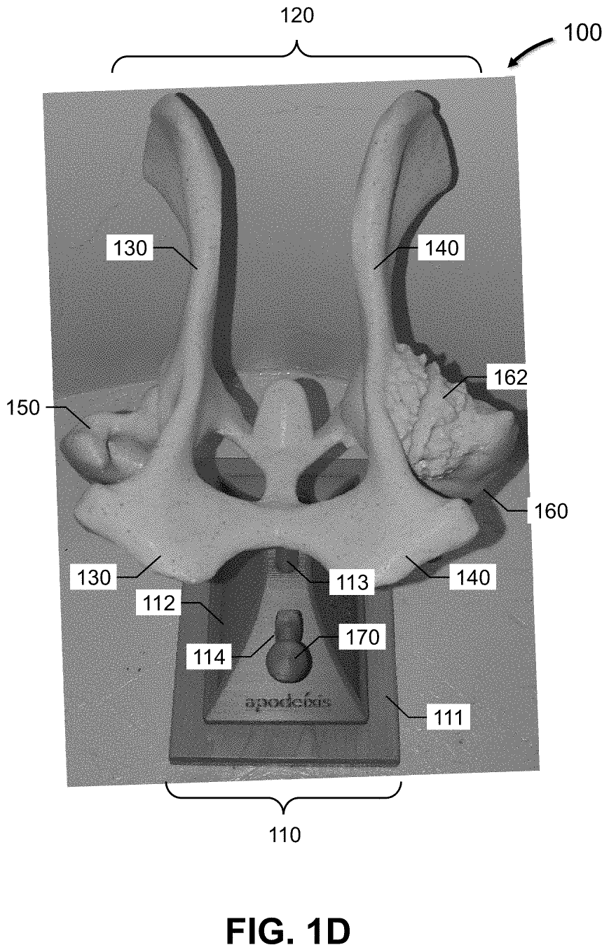

FIGS. 1A, 1B, 1C and 1D depict front, left oblique, right oblique and top views, respectively, of demonstration model 100, in accordance with embodiments of the present disclosure.

In many embodiments, demonstration model 100 includes, inter alia, support 110, pelvis 120 including healthy hip 130 and diseased hip 140, healthy femur 150, and diseased femur 160. In certain embodiments, demonstration model 100 may include, inter alia, support 110, healthy hip 130, and healthy femur 150, while in other embodiments, demonstration model 100 may include, inter alia, support 110, diseased hip 140, and diseased femur 160. In many embodiments, femoral implant 170, ball socket insert 180, and spacer 190 are also included.

Support 110 includes base 111, cover 112, and vertical member 113. Cover 112 may define a cylindrical (or other shape) recess 114 with a surface that is configured to receive femoral implant 170. The surface may include at least one embedded magnet to releasably secure femoral implant 170 within recess 114. Cover 112 may also define a spherical (or other shape) recess 115 with a surface that is configured to receive ball socket insert 180. The surface may include at least one embedded magnet to releasably secure ball socket insert 180 within recess 115. Cover 112 may depict the name of the modeled surgical procedure, the name of the customer (practice, vendor, etc.), etc.

In certain embodiments, base 111 and vertical member 113 are wood, and cover 112 is plastic, which may be formed by 3D printing, injection molding, etc. In other embodiments, all of the components are plastic, wood, aluminum, etc.

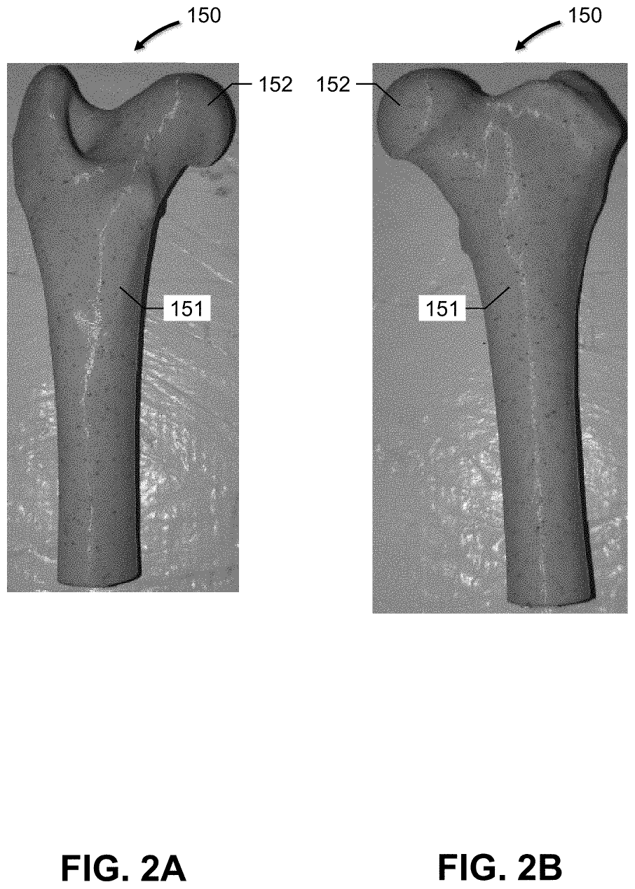

FIGS. 2A and 2B depict front and rear views, respectively, of healthy femur 150, in accordance with embodiments of the present disclosure.

Healthy femur 150 includes stem 151 and head 152 with one or more embedded magnets (not visible) that that couple head 152 to the hip socket of healthy hip 130.

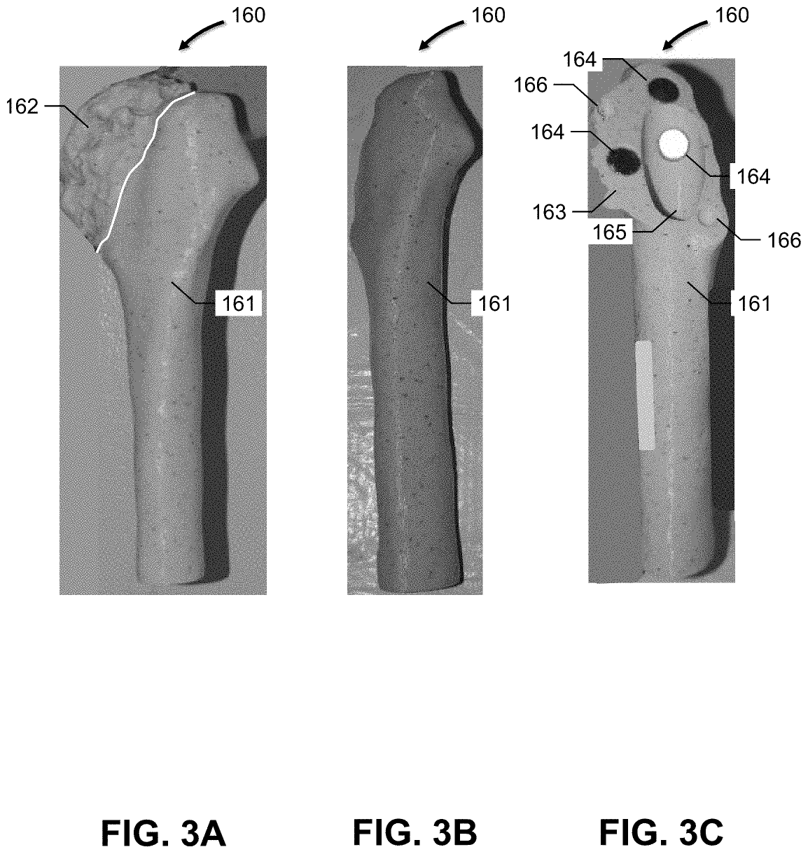

FIG. 3A depicts a front view of diseased femur 160 with removable proximal portion 162, in accordance with embodiments of the present disclosure.

Diseased femur 160 includes stem 161 and removable proximal portion 162.

FIGS. 3B and 3C depict font and rear views, respectively, of diseased femur 160 without removable proximal portion 162, in accordance with embodiments of the present disclosure.

Stem 161 includes upper inclined surface 163 that provides an interface for the lower surface of removable proximal portion 162, and is inclined with respect to the horizontal plane. Stem 161 and upper inclined surface 163 define canal or recess 165 with a cylindrical surface in which the stem of femoral implant 170 may be inserted. The cylindrical surface may include one or more embedded magnets to secure femoral implant 170 within recess 165.

Upper inclined surface 163 includes one or more embedded magnets (two in the depicted embodiment) that cooperate with embedded magnets on the lower surface of proximal portion 162 to secure proximal portion 162 to upper inclined surface 163 of diseased femur 160. Upper inclined surface 163 may also include one or more indentations, holes or recesses 166 (two in the depicted embodiment) to receive cooperating locating pins protruding from the lower surface of proximal portion 162 to align proximal portion 162 on upper inclined surface 163 of diseased femur 160.

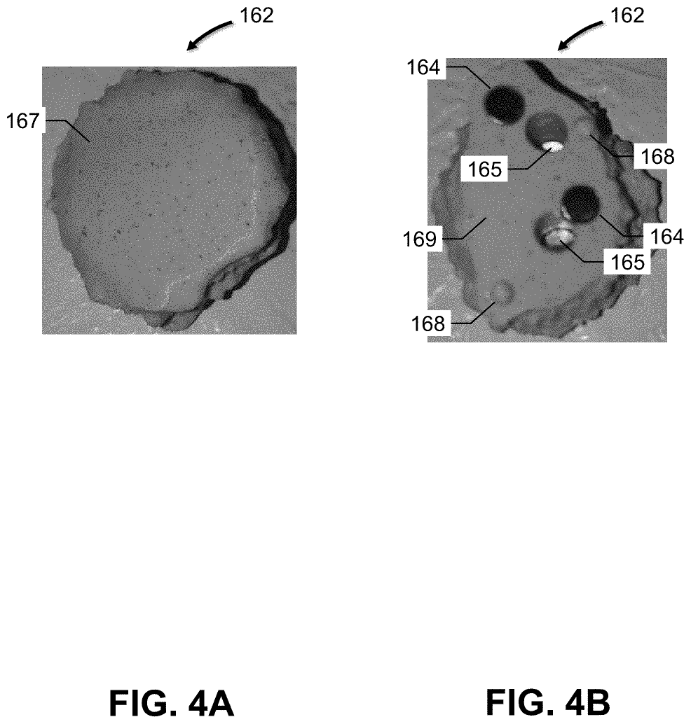

FIGS. 4A and 4B depict top and bottom views, respectively, of proximal portion 162 of diseased femur 160, in accordance with embodiments of the present disclosure.

Proximal portion 162 has an upper surface 167 and lower surface 169. Upper surface 167 includes one or more embedded magnets 164 (two visible through lower surface 169 in this embodiment) that couple proximal portion 162 to the hip socket of diseased hip 140. Lower surface 169 includes one or more embedded magnets (two depicted in this embodiment) that couple proximal portion 162 to upper inclined surface 163 of diseased femur 160, and one or more locating pins 168 (two depicted in this embodiment) protruding therefrom that align proximal portion 162 on upper inclined surface 163 of diseased femur 160.

Diseased hip 140 depicts a hip with advanced osteoarthritis (e.g., proliferative bone spurs). Diseased hip 140 is very shallow and depicts the ongoing poor strength and stability of a dysplastic hip as it develops osteoarthritis. Proximal portion 162, representing the femoral head and neck of diseased femur 160, may be removed to demonstrate surgical removal of the femoral head and neck associated with femoral head and neck ostectomy surgery as well as the femoral portion of total hip replacement surgery.

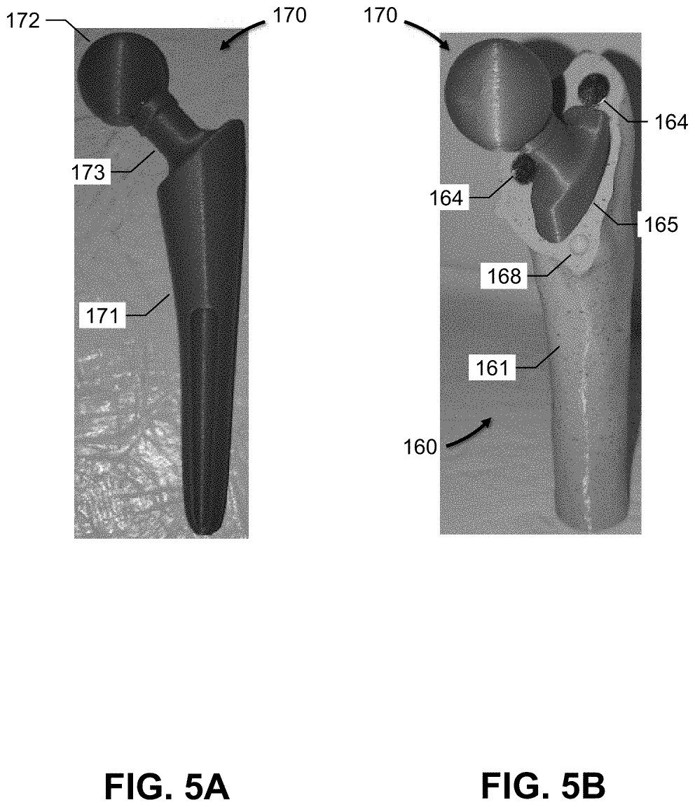

FIG. 5A depicts a side view of femoral implant 170, in accordance with embodiments of the present disclosure.

Femoral implant 170 includes stem 171, neck 173 and head 172 with one or more embedded magnets (not visible) that that couple head 172 to the hip socket of diseased hip 140. Femoral implant 170 may be grey in color to simulate the titanium of a true implant.

FIG. 5B depicts a front view of diseased femur 160 with femoral implant 170, in accordance with embodiments of the present disclosure.

Femoral implant 170 has been inserted into recess 165 of stem 161 of diseased femur 160 and magnetically secured therein. Other coupling mechanisms are also supported, such as, for example, a press fit, etc. While embedded magnets 164 and locating pin(s) 168 are visible, these components not used in this configuration. When not in use, femoral implant 170 may be stored in recess 114 in base 111.

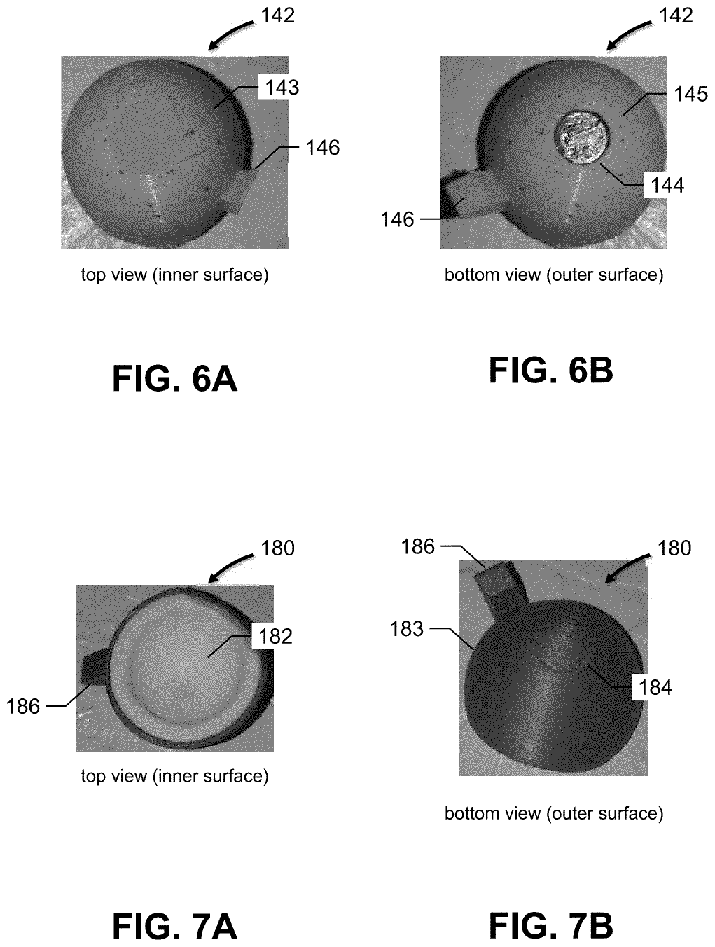

FIGS. 6A and 6B depict top and bottom views, respectively, of removable socket insert 142, in accordance with embodiments of the present disclosure.

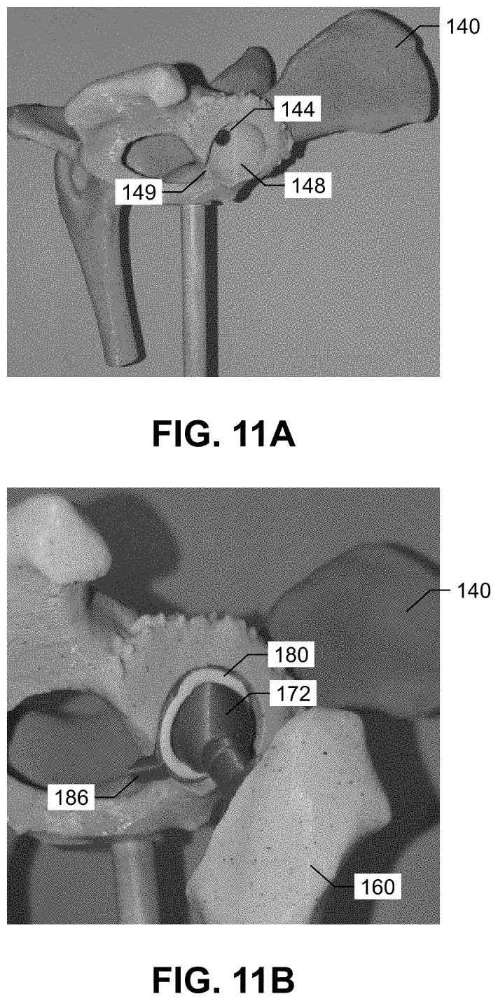

Socket insert 142 has convex spherical inner surface 143, convex spherical outer surface 145 with embedded magnet 144, and tab 146. Socket insert 142 is removably attached within the socket of diseased hip 140, and couples either upper surface 167 of proximal portion 162 or head 172 of femoral implant 170 to the hip socket of diseased hip 140. Socket insert 142 is magnetically coupled to one or more embedded magnets with the socket of diseased hip 140. Tab 146 is configured to engage cutout 149 in the perimeter of recess 148 (see FIG. 11A).

Socket insert 142 generally represents the amount of material that is removed during the pelvic portion of total hip replacement surgery. When not in use, socket insert 142 may be stored in recess 115 in base 111.

FIGS. 7A and 7B depict top and bottom views, respectively, of removable ball socket insert 180, in accordance with embodiments of the present disclosure.

Ball socket insert 180 (also known as a pelvic implant or cup) has convex spherical inner surface 182, convex spherical outer surface 183 with embedded magnet 184, and tab 186. Ball socket insert 180 is removably attached within the socket of diseased hip 140, and couples head 172 of femoral implant 170 to the hip socket of diseased hip 140. Ball socket insert 180 is magnetically coupled to one or more embedded magnets with the socket of diseased hip 140. Tab 186 is configured to engage cutout 149 in the perimeter of recess 148 (see FIG. 11A).

Ball socket insert 180 may have grey and white portions to simulate the titanium and plastic of a true implant. When not in use, ball socket insert 180 may be stored in recess 115 in base 111.

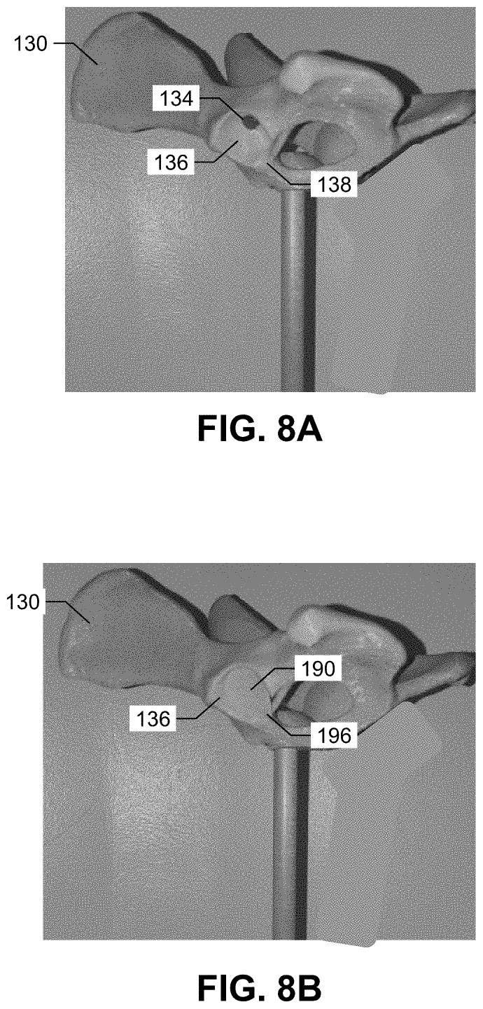

FIG. 8A depicts a front isometric view of demonstration model 100 showing hip socket or recess 136 in healthy hip 130, in accordance with embodiments of the present disclosure.

Generally, healthy hip 130 has a body that defines recess 136 which has a surface with one or more embedded magnets 134 and a perimeter with cutout 138. Recess 136 is configured to receive and secure head 152 of healthy femur 150 or removable spacer 190.

FIG. 8B depicts a front isometric view of demonstration model 100 showing removable spacer 190 disposed in recess 136 in healthy hip 130, in accordance with embodiments of the present disclosure.

Tab 196 of removable spacer 190 has engaged cutout 138 in the perimeter of recess 136.

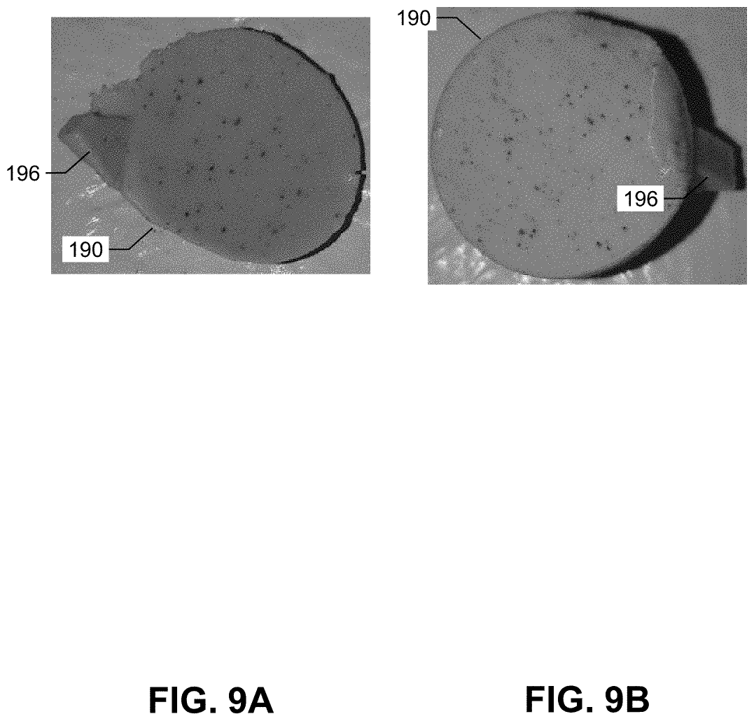

FIGS. 9A and 9B depict top and bottom views, respectively, of removable spacer 190, in accordance with embodiments of the present disclosure.

Removable spacer 190 includes one or more embedded magnets (not visible) to magnetically engage embedded magnet(s) 134 within the surface of recess 136. Removable spacer 190 also include tab 196 to engage cutout 138 in the perimeter of recess 136.

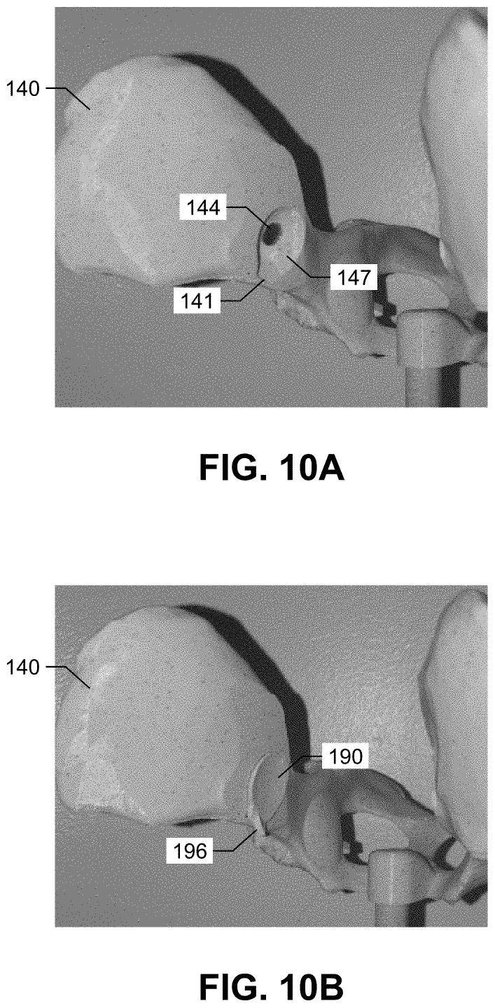

FIG. 10A depicts a rear view of demonstration model 100 showing storage cavity 147 for removable spacer 190, in accordance with embodiments of the present disclosure.

Generally, diseased hip 140 has a body that defines storage cavity 147 which has a surface with one or more embedded magnets 144 and a perimeter with cutout 149. Storage cavity 147 is configured to receive and removable spacer 190. Storage cavity may also be located in healthy hip 130 or cover 112.

FIG. 10B depicts rear view of demonstration model 100 showing removable spacer 190 disposed in storage cavity 147 located in diseased hip 140, in accordance with embodiments of the present disclosure.

Tab 196 of removable spacer 190 has engaged cutout 141 in the perimeter of storage cavity 147.

FIG. 11A depicts a front isometric view of demonstration model 100 showing hip socket or recess 148 in diseased hip 140, in accordance with embodiments of the present disclosure.

Generally, diseased hip 140 has a body that defines recess 148 which has a surface with one or more embedded magnets 144 and a perimeter with cutout 149. Recess 148 is configured to receive socket insert 142, which couples proximal portion 162 of diseased femur 160 or head 172 of femur implant 170 to diseased hip 140. Recess 148 is also configured to receive ball socket insert 180, which couples head 172 of femur implant 170 to diseased hip 140.

FIG. 11B depicts a front isometric view of demonstration model 100 showing head 172 of femoral implant 170 coupled to ball socket insert 180 in diseased hip 140, in accordance with embodiments of the present disclosure.

Tab 186 of ball socket insert 180 has engaged cutout 149 in the perimeter of recess 148, and femoral implant 170 has been inserted within diseased femur 160.

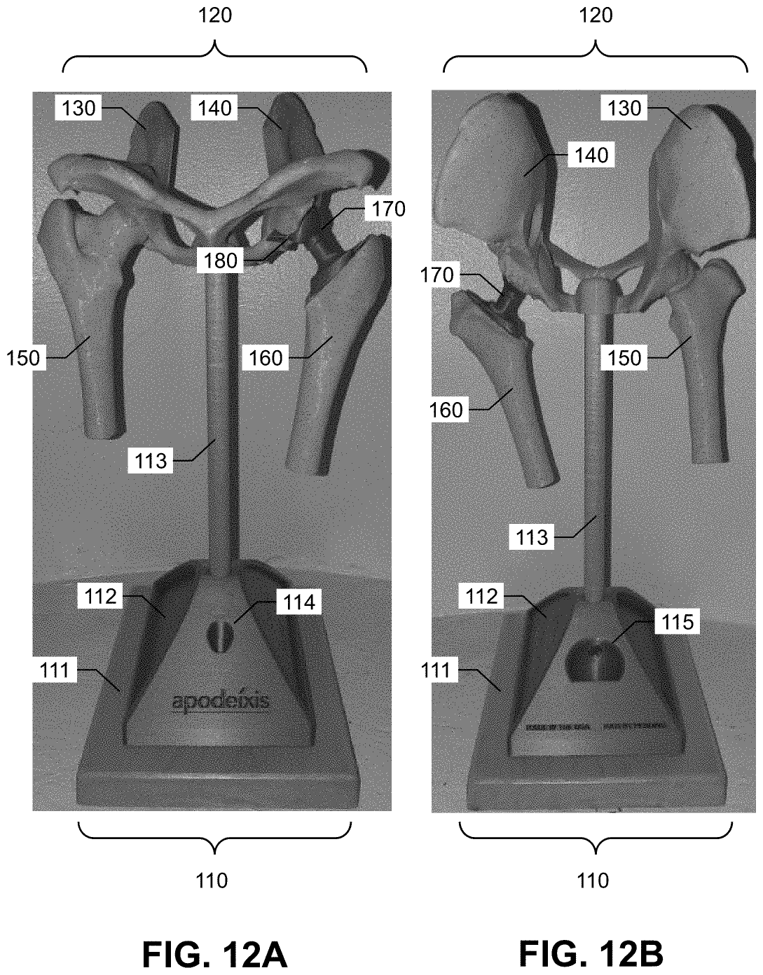

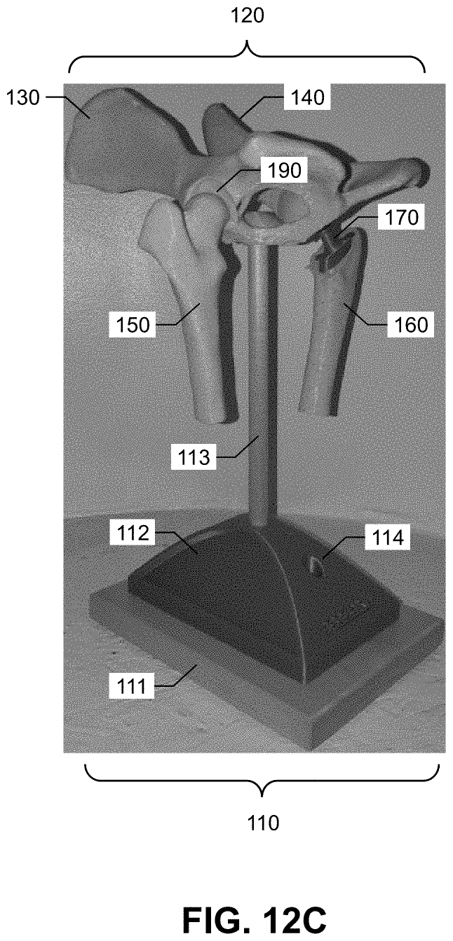

FIGS. 12A, 12B and 12C depict front, rear and oblique views, respectively, of demonstration model 100 with femoral implant 170, ball socket insert 180, and removable spacer 190, in accordance with embodiments of the present disclosure.

Elements identified include support 110 with base 111, cover 112, vertical member 113, recess 114, recess 115, pelvis 120, healthy hip 130, diseased hip 140, healthy femur 150, diseased femur 160, femoral implant 170, ball socket insert 180, and removable spacer 190.

The hips of the total hip replacement demonstration model can be rotated at any position attainable by the dog hip they represent. Additionally, the total hip replacement demonstration model transforms between an injured, pre-operative state, and the post-operative state. For example, the detachable proximal (upper) portion of the diseased femur can be removed and replaced by the femoral implant to demonstrate femoral head and neck ostectomy surgery. Additionally, the detachable proximal (upper) portion of the diseased femur can be removed and replaced by the femoral implant, and the socket insert (center portion) of the diseased hip socket can be removed and replaced by the ball socket insert (pelvic implant) to demonstrate how total hip replacement surgery improves the function of the hip from its pre-operative state to its post-operative state.

In many embodiments, healthy hip 130 and diseased hip 140, socket insert 142, healthy femur 150, disease femur 160 and proximal portion 162, femoral implant 170, ball socket insert 180, and spacer 190 are plastic formed by 3D printing, a set of molds, etc. Other materials are also supported, such as wood, aluminum, etc.

Advantageously, the total hip replacement demonstration model illustrates, inter alia:
the normal action of the hip and the normal role of the pelvis and femur;
the dysfunction caused by a shallow, dysplastic hip;
the progression to osteoarthritis; and
the steps of treatment via femoral head and neck ostectomy surgery or total hip replacement surgery surgical procedures, and how the procedures restore the stability of the hip.

The total hip replacement demonstration model includes hidden magnets that allow both femurs to remain coupled to their respective hips, i.e., either with the removable spacer in place, or with the removable spacer removed; with the detachable upper portion of the second femur present, or with the femoral implant present; and with the removeable center portion of the second hip socket present, or with the pelvic implant present.

The following embodiments are combinable.

One embodiment is a three-dimensional model for demonstrating an osteotomy surgical procedure, including a support, a hip, attached to the support, including a body defining a socket having a surface including at least one embedded magnet, a spacer, removably couplable to the socket surface, including at least one embedded magnet, and a femur, including a stem, and a head, including at least one embedded magnet, configured to cooperate with the socket surface or the spacer to removably couple the femur to the hip.

A further embodiment is the three-dimensional model where when the spacer is not coupled to the socket surface, the hip is arranged in a healthy hip state, and when the spacer is coupled to the socket surface, the hip is arranged in a shallow dysplastic hip state.

A further embodiment is the three-dimensional where the hip body further defines a storage cavity having a surface including at least one embedded magnet, and the spacer is removably couplable to the storage cavity surface.

Another embodiment is the three-dimensional model where the support includes a base, a vertical member attached to the base and the hip, and a cover that defines at least a storage cavity having a surface including at least one embedded magnet, and the spacer is removably couplable to the storage cavity surface.

One embodiment is a three-dimensional model for demonstrating an osteotomy surgical procedure, including a support, a hip, attached to the support, including a body defining a socket having a surface including at least one embedded magnet, a socket insert, removably couplable to the socket surface, including at least one embedded magnet, and a femur, including a stem including an upper surface having at least one embedded magnet, and a body defining a recess including a surface with at least one embedded magnet, and a proximal portion including an upper surface having at least one embedded magnet, and a lower surface having at least one embedded magnet, where the proximal portion lower surface is configured to cooperate with the stem upper surface to removably couple the proximal portion to the stem, and where the proximal portion upper surface is configured to cooperate with the socket insert to removably couple the femur to the hip.

A further embodiment is the three-dimensional model, further including a femoral implant including a head having at least one embedded magnet, and a shaft having at least one embedded magnet, where the femoral implant is configured to replace the femur proximal portion, where the femoral implant shaft is configured to cooperate with the femur body recess surface to removably couple the femoral implant to the femur stem, and where the femoral implant head is configured to cooperate with the socket insert to removably couple the femur to the hip.

A further embodiment is the three-dimensional model where a ball socket insert, removably couplable to the hip body socket surface, including at least one embedded magnet, where the ball socket insert is configured to replace the socket insert, and where the femoral implant head is configured to cooperate with the ball socket insert to removably couple the femur to the hip.

Another embodiment is the three-dimensional model where when the socket insert is coupled to the hip body socket surface and the proximal portion is coupled to the femur stem, the hip is arranged in an osteoarthritis state, and when the ball socket insert is coupled to the hip body socket surface and the femoral implant is coupled to the femur stem, the hip is arranged in a total hip replacement state.

Another embodiment is the three-dimensional model where the support includes a base, a vertical member attached to the base and the hip, and a cover that defines at least one storage cavity having a surface including at least one embedded magnet, and the femoral implant is removably couplable to the storage cavity surface.

A further embodiment is the three-dimensional model where the support includes a base, a vertical member attached to the base and the hip, and a cover that defines at least one storage cavity having a surface including at least one embedded magnet, and the ball socket insert is removably couplable to the storage cavity surface.

One embodiment is a three-dimensional model for demonstrating an osteotomy surgical procedure, including a support, a healthy hip, attached to the support, including a body defining a socket having a surface, a diseased hip, attached to the support, including a body defining a socket having a surface, a healthy femur removably couplable to the healthy hip, a diseased femur, removably couplable to the diseased hip, including a removable proximal portion, a spacer removably couplable to the healthy hip socket surface, a socket insert removably couplable to the diseased hip socket surface, a ball socket insert, removably couplable to the diseased hip socket surface, configured to replace the socket insert; and a femoral implant, removably couplable to the diseased femur, configured to replace the diseased femur proximal portion.

A further embodiment is the three-dimensional model where the spacer includes at least one embedded magnet the healthy hip socket surface includes at least one embedded magnet; and the healthy femur includes a stem, and a head, including at least one embedded magnet, configured to cooperate with the healthy hip socket surface or the spacer to removably couple the healthy femur to the healthy hip.

Another embodiment is the three-dimensional model where when the spacer is not coupled to the healthy hip socket surface, the healthy hip is arranged in a healthy hip state, and when the spacer is coupled to the healthy hip socket surface, the healthy hip is arranged in a shallow dysplastic hip state.

Another embodiment is the three-dimensional model where the socket insert includes at least one embedded magnet, the diseased hip socket surface includes at least one embedded magnet, the diseased femur further includes a stem including an upper surface having at least one embedded magnet, and a body defining a recess including a surface with at least one embedded magnet; and the diseased femur proximal portion includes a lower surface, having at least one embedded magnet, configured to cooperate with the diseased femur stem upper surface to removably couple the diseased femur proximal portion to the diseased femur stem, and an upper surface, having at least one embedded magnet, configured to cooperate with the socket insert to removably couple the diseased femur to the diseased hip.

A further embodiment is the three-dimensional model where the femoral implant includes a head having at least one embedded magnet, and a shaft having at least one embedded magnet, the femoral implant is configured to replace the diseased femur proximal portion, the femoral implant shaft is configured to cooperate with the diseased femur recess surface to removably couple the femoral implant to the diseased femur stem, and the femoral implant head is configured to cooperate with the socket insert to removably couple the diseased femur to the diseased hip.

A further embodiment is the three-dimensional model where the ball socket insert includes at least one embedded magnet; and the femoral implant head is configured to cooperate with the ball socket insert to removably couple the diseased femur to the diseased hip.

Another embodiment is the three-dimensional model where when the socket insert is coupled to the diseased hip socket surface and the diseased femur proximal portion is coupled to the diseased femur stem, the diseased hip is arranged in an osteoarthritis state; and when the ball socket insert is coupled to the diseased hip socket surface and the femoral implant is coupled to the diseased femur stem, the diseased hip is arranged in a total hip replacement state.

Another embodiment is the three-dimensional model where the healthy hip body or the diseased hip body defines a storage cavity having a surface including at least one embedded magnet, and the spacer is removably couplable to the storage cavity surface.

Another embodiment is the three-dimensional model according to claim 11, where the support includes a base, a vertical member attached to the base, the healthy hip and the diseased hip, and a cover that defines at least one storage cavity having a surface including at least one embedded magnet, and the femoral implant is removably couplable to one storage cavity surface.

A further embodiment is the three-dimensional model where the ball socket insert is removably couplable to another storage cavity surface.

While implementations of the disclosure are susceptible to embodiment in many different forms, there is shown in the drawings and will herein be described in detail specific embodiments, with the understanding that the present disclosure is to be considered as an example of the principles of the disclosure and not intended to limit the disclosure to the specific embodiments shown and described. In the description above, like reference numerals may be used to describe the same, similar or corresponding parts in the several views of the drawings.

The many features and advantages of the disclosure are apparent from the detailed specification, and, thus, it is intended by the appended claims to cover all such features and advantages of the disclosure which fall within the scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. A three-dimensional model for demonstrating an osteotomy surgical procedure, comprising:
a support;
a hip, attached to the support, including a body defining a socket having a surface including at least one embedded magnet;
a spacer, removably couplable to the socket surface, including at least one embedded magnet; and
a femur, including:
a stem, and
a head, including at least one embedded magnet, configured to cooperate with the socket surface or the spacer to removably couple the femur to the hip.

2. The three-dimensional model according to claim 1, where:
when the spacer is not coupled to the socket surface, the hip is arranged in a healthy hip state; and
when the spacer is coupled to the socket surface, the hip is arranged in a shallow dysplastic hip state.

3. The three-dimensional model according to claim 1, where:
the hip body further defines a storage cavity having a surface including at least one embedded magnet; and
the spacer is removably couplable to the storage cavity surface.

4. The three-dimensional model according to claim 1, where:
the support includes a base, a vertical member attached to the base and the hip, and a cover that defines at least a storage cavity having a surface including at least one embedded magnet; and
the spacer is removably couplable to the storage cavity surface.

5. A three-dimensional model for demonstrating an osteotomy surgical procedure, comprising:
a support;
a hip, attached to the support, including a body defining a socket having a surface including at least one embedded magnet;
a socket insert, removably couplable to the socket surface, including at least one embedded magnet; and
a femur, including:
a stem including an upper surface having at least one embedded magnet, and a body defining a recess including a surface with at least one embedded magnet, and
a proximal portion including an upper surface having at least one embedded magnet, and a lower surface having at least one embedded magnet,
where the proximal portion lower surface is configured to cooperate with the stem upper surface to removably couple the proximal portion to the stem, and
where the proximal portion upper surface is configured to cooperate with the socket insert to removably couple the femur to the hip.

6. The three-dimensional model according to claim 5, further comprising:
a femoral implant including a head having at least one embedded magnet, and a shaft having at least one embedded magnet,
where the femoral implant is configured to replace the femur proximal portion,
where the femoral implant shaft is configured to cooperate with the femur body recess surface to removably couple the femoral implant to the femur stem, and
where the femoral implant head is configured to cooperate with the socket insert to removably couple the femur to the hip.

7. The three-dimensional model according to claim 6, further comprising:
a ball socket insert, removably couplable to the hip body socket surface, including at least one embedded magnet,
where the ball socket insert is configured to replace the socket insert, and
where the femoral implant head is configured to cooperate with the ball socket insert to removably couple the femur to the hip.

8. The three-dimensional model according to claim 7, where:
when the socket insert is coupled to the hip body socket surface and the proximal portion is coupled to the femur stem, the hip is arranged in an osteoarthritis state; and
when the ball socket insert is coupled to the hip body socket surface and the femoral implant is coupled to the femur stem, the hip is arranged in a total hip replacement state.

9. The three-dimensional model according to claim 6, where:
the support includes a base, a vertical member attached to the base and the hip, and a cover that defines at least one storage cavity having a surface including at least one embedded magnet; and
the femoral implant is removably couplable to the storage cavity surface.

10. The three-dimensional model according to claim 7, where:
the support includes a base, a vertical member attached to the base and the hip, and a cover that defines at least one storage cavity having a surface including at least one embedded magnet; and
the ball socket insert is removably couplable to the storage cavity surface.

11. A three-dimensional model for demonstrating an osteotomy surgical procedure, comprising:
a support;
a healthy hip, attached to the support, including a body defining a socket having a surface;
a diseased hip, attached to the support, including a body defining a socket having a surface;
a healthy femur removably couplable to the healthy hip;
a diseased femur, removably couplable to the diseased hip, including a removable proximal portion;
a spacer removably couplable to the healthy hip socket surface;
a socket insert removably couplable to the diseased hip socket surface;
a ball socket insert, removably couplable to the diseased hip socket surface, configured to replace the socket insert; and
a femoral implant, removably couplable to the diseased femur, configured to replace the diseased femur proximal portion.

12. The three-dimensional model according to claim 11, where:
the spacer includes at least one embedded magnet;
the healthy hip socket surface includes at least one embedded magnet; and
the healthy femur includes:
a stem, and
a head, including at least one embedded magnet, configured to cooperate with the healthy hip socket surface or the spacer to removably couple the healthy femur to the healthy hip.

13. The three-dimensional model according to claim 12, where:
when the spacer is not coupled to the healthy hip socket surface, the healthy hip is arranged in a healthy hip state; and
when the spacer is coupled to the healthy hip socket surface, the healthy hip is arranged in a shallow dysplastic hip state.

14. The three-dimensional model according to claim 11, where:
the socket insert includes at least one embedded magnet;
the diseased hip socket surface includes at least one embedded magnet;
the diseased femur further includes:
a stem including an upper surface having at least one embedded magnet, and a body defining a recess including a surface with at least one embedded magnet; and
the diseased femur proximal portion includes:
a lower surface, having at least one embedded magnet, configured to cooperate with the diseased femur stem upper surface to removably couple the diseased femur proximal portion to the diseased femur stem, and
an upper surface, having at least one embedded magnet, configured to cooperate with the socket insert to removably couple the diseased femur to the diseased hip.

15. The three-dimensional model according to claim 14, where:
the femoral implant includes a head having at least one embedded magnet, and a shaft having at least one embedded magnet;
the femoral implant is configured to replace the diseased femur proximal portion;
the femoral implant shaft is configured to cooperate with the diseased femur recess surface to removably couple the femoral implant to the diseased femur stem; and
the femoral implant head is configured to cooperate with the socket insert to removably couple the diseased femur to the diseased hip.

16. The three-dimensional model according to claim 15, where:
the ball socket insert includes at least one embedded magnet; and
the femoral implant head is configured to cooperate with the ball socket insert to removably couple the diseased femur to the diseased hip.

17. The three-dimensional model according to claim 16, where:
when the socket insert is coupled to the diseased hip socket surface and the diseased femur proximal portion is coupled to the diseased femur stem, the diseased hip is arranged in an osteoarthritis state; and
when the ball socket insert is coupled to the diseased hip socket surface and the femoral implant is coupled to the diseased femur stem, the diseased hip is arranged in a total hip replacement state.

18. The three-dimensional model according to claim 11, where:
the healthy hip body or the diseased hip body defines a storage cavity having a surface including at least one embedded magnet; and
the spacer is removably couplable to the storage cavity surface.

19. The three-dimensional model according to claim 11, where:
the support includes a base, a vertical member attached to the base, the healthy hip and the diseased hip, and a cover that defines at least one storage cavity having a surface including at least one embedded magnet; and
the femoral implant is removably couplable to one storage cavity surface.

20. The three-dimensional model according to claim 19, where the ball socket insert is removably couplable to another storage cavity surface.
